(19) United States
(12) Patent Application Publication
(10) Pub. No.: US 2006/0020615 A1
(43) Pub. Date: Jan. 26, 2006

(54) Method of automatically including parenthetical information from set databases while creating a document

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Jack V. Musgrove, 2911 Briona Wood Lane, Cedar Park, TX, 78613, US

(73) Assignee: INTERNATIONAL BUSINESS MACHINES CORPORATION, ARMONK, NY (US)

(21) Appl. No.: 10/896,503

(22) Filed: Jul. 22, 2004

(51) Int. Cl. G06F 17/00

(52) U.S. Cl. 707/101

(57) ABSTRACT

A method of creating an electronic document by entering data into the electronic document, searching one or more information sets to identify a set entry which matches a portion of the entered data, and inserting a link to information from the set entry into the electronic document, wherein the link is associated with the matched portion of the entered data. Searching occurs automatically as the data is entered, and different information sets can be designated for searching from among a plurality of available information sets, such as database files, file folders, web browser bookmarks, or email address books. The link is inserted in response to selection of the set entry for inclusion in the electronic document, particularly when multiple matches to parenthetical information are found. In the example where the set entry is a separate file and the document is an email message, the link points to the separate file as an attachment to the email message.

### BACKGROUND OF THE INVENTION

1. Field of the Invention

The present invention generally relates to computer systems, and more specifically to a method and system for creating or examining electronic documents, particularly documents which are transmitted across a computer network.

2. Description of the Related Art

A generalized computing network 2 is shown in FIG. 1. Network 2 has several client workstations 3a, 3b, 3c, and 3d which are interconnected via a communications infrastructure 4. Network 2 also has servers 5a, 5b. Each server is essentially a stand-alone computer system (having one or more processors, memory devices, and communications devices), but has been adapted to primarily provide information to individual users at client workstations 3a-3d. The information provided by a server can be in the form of programs which run locally on a given client, or in the form of data such as files used by other programs. Communications infrastructure 4 may include transmission media such as copper wires or optical fibers, along with routers, hubs and switches.

Clients 3a-3d can also be stand-alone computer systems (like personal computers, or PCs), or “dumber” systems adapted for limited use with network 2 (like network computers, or NCs). As used herein, “PC” generally refers to any multi-purpose computer adapted for use by one or more individuals, regardless of the manufacturer, hardware platform, operating system, etc. Network 2 thus offers client-server communications as well as peer-to-peer communications between different clients in real-time or by delayed file delivery. Other nodes can be included in network 2, such as a storage device 6.

The network can be local in nature, or can be further connected to other network systems (not shown). The construction of network 2 is also generally applicable to the Internet. Conventional protocols and services have been established for the Internet which allow the transfer of various types of information, including electronic mail, simple file transfers via FTP, remote computing via TELNET, “gopher” searching, Usenet newsgroups, and hypertext file delivery and multimedia streaming via the World Wide Web (WWW). A given server can be dedicated to performing one of these operations, or run multiple services. For example, mail servers (sending and receiving) can be used to facilitate the transmission of email. The Internet is becoming increasingly popular as the primary medium for both personal and commercial transactions.

Internet services are typically accessed by specifying a unique address, or universal resource locator (URL). The URL has two basic components, the protocol to be used, and the object pathname. For example, the URL “http://www.uspto.gov” (home page for the U.S. Patent & Trademark Office) specifies a hypertext transfer protocol (“http”) and a pathname of the server (“www.uspto.gov”). The server name is associated with a unique numeric value (a TCP/IP address/domain). For email (“mailto:” protocol), the address is composed of two parts, a user name and a server name separated by the commercial “at” symbol, e.g., “johndoe@mailserver.com”.

The present invention relates to the creation of electronic documents which can be transmitted on a network like the Internet, and is particularly applicable to the creation of email. As illustrated in FIG. 1, a document creator at client workstation 3a uses an editor (e.g., an email composer) to draft a document such as an email 7. This email is then transmitted across the communications infrastructure 4 to the document recipient at client workstation 3b who views it with a document reader (e.g., a web browser). A typical email can have other components besides the main body of text. For example, an email may have one or more attachments which can be considered as files separate from the email message itself. An email can also have embedded hypertext links for accessing WWW pages.

When a document such as an email is transmitted and read by the recipient, there are often pieces of information within the document that might be of further interest to the recipient, but the document author has failed to provide sufficient details to allow the recipient to follow up this interest. This situation frequently occurs when the missing details are implicit to the author, e.g., referring to a third party who is known to the author but unknown to the recipient. Consider the example of a company employee who is writing to a co-worker about a current project. The employee might send an email referring to an individual by first name only (“Sue”), but the co-worker has no idea who that individual is. The email might also refer to a named spreadsheet file, but that file is unavailable to the document recipient. In this example, the co-worker might want to contact the other individual and review the spreadsheet, but this cannot be accomplished without further effort and investigation, such as sending a reply back to the original employee requesting clarification. While the document author could explicitly include all of these details, manually entering all of the associated information can be unduly burdensome, and can further make the email message more difficult to read as more and more parenthetical information is inserted.

In light of the foregoing, it would be desirable to devise an improved method of document creation which facilitated the inclusion of such parenthetical information for the document recipient. It would be further advantageous if the method could provide flexibility in the designation and selection of such information.

### SUMMARY OF THE INVENTION

It is therefore one object of the present invention to provide an improved method of creating an electronic document.

It is another object of the present invention to provide such a method which allows a document author to include parenthetical information in an effortless and transparent manner.

It is yet another object of the present invention to provide an improved method of accessing information provided over a computer network.

The foregoing objects are achieved in a method of creating an electronic document by entering data into the electronic document, searching one or more information sets to identify a set entry which matches a portion of the entered data, and inserting a link to information from the set entry into the electronic document, the link being associated with the matched portion of the entered data. Searching occurs automatically as the data is entered, and various information sets can be designated for searching from among a plurality of available information sets, such as database files, file folders, web browser bookmarks, or email address books. The link is inserted in response to selection of the set entry for inclusion in the electronic document. In the example where the set entry is a separate file and the document is an email message, the link points to the separate file as an attachment to the email message.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a pictorial representation of electronic document delivery across a conventional communications network having various nodes such as client workstations, servers, and storage devices;

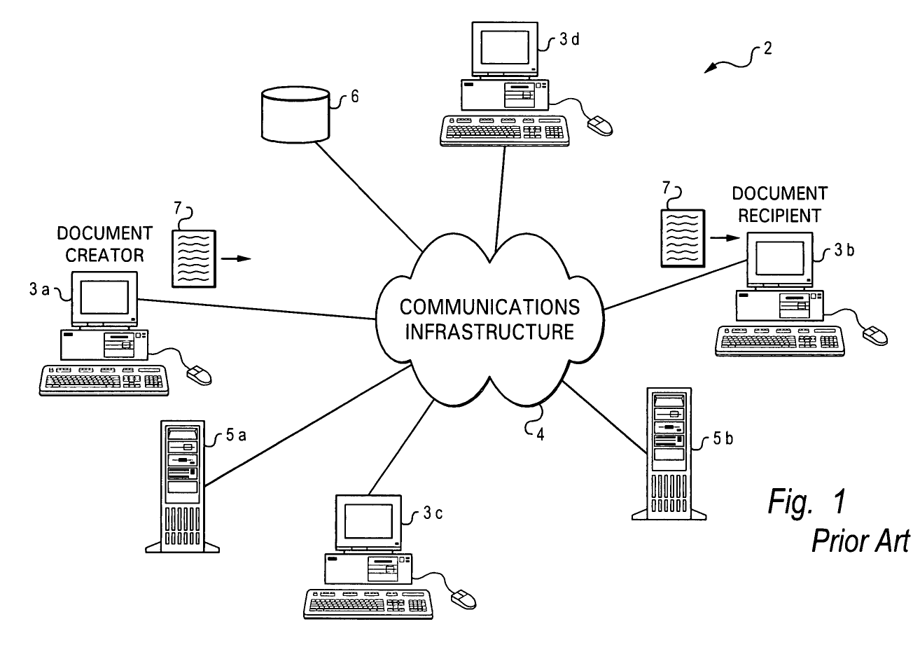

FIG. 2 is a block diagram of a computer system programmed to carry out document creation with linked parenthetical information in accordance with one implementation of the present invention;

FIGS. 3A and 3B are elevational views of a document editor application as displayed on a computer screen, depicting document creation with linked parenthetical information in accordance with one implementation of the present invention;

FIG. 4 is an elevational view of a document reader application as displayed on a computer screen, depicting review of the document created in FIGS. 3A and 3B in accordance with one implementation of the present invention;

FIG. 5 is a chart illustrating the logical flow of the selection and ordering of databases used to search parenthetical information in accordance with one implementation of the present invention; and

FIG. 6 is a chart illustrating the logical flow of document creation with parenthetical information linking in accordance with one implementation of the present invention.

The use of the same reference symbols in different drawings indicates similar or identical items.

### DESCRIPTION OF THE PREFERRED EMBODIMENT(S)

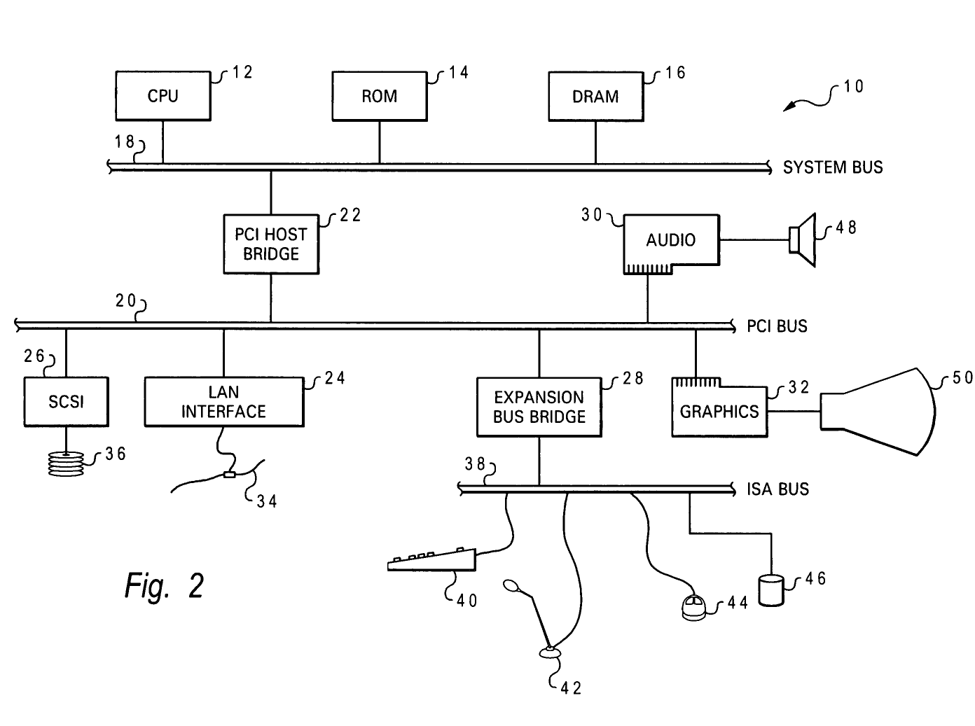

The present invention provides a method of creating electronic documents which allows the document author to effortlessly and transparently include parenthetical information with a document. The invention utilizes a program application such as an enhanced email composer to create the enhanced documents, as explained further below, which is executed on a data processing system or computer. FIG. 2 depicts one embodiment 10 of a computer system programmed to carry out electronic document creation in accordance with one implementation of the present invention. System 10 includes a central processing unit (CPU) 12 which carries out program instructions, firmware or read-only memory (ROM) 14 which stores the system's basic input/output logic, and a dynamic random access memory (DRAM) 16 which temporarily stores program instructions and operand data used by CPU 12. CPU 12, ROM 14 and DRAM 16 are all connected to a system bus 18. There may be additional structures in the memory hierarchy which are not depicted, such as on-board (L1) and second-level (L2) caches.

CPU 12, ROM 14 and DRAM 16 are also coupled to a peripheral component interconnect (PCI) local bus 20 using a PCI host bridge 22. PCI host bridge 22 provides a low latency path through which processor 12 may access PCI devices mapped anywhere within bus memory or I/O address spaces. PCI host bridge 22 also provides a high bandwidth path to allow the PCI devices to access DRAM 16. Attached to PCI local bus 20 are a network adapter 24, a small computer system interface (SCSI) adapter 26, an expansion bus bridge 28, an audio adapter 30, and a graphics adapter 32. Network adapter 24 may be used to connect computer system 10 to an external computer network 34, such as a local area network (LAN) or the Internet. Small computer system interface (SCSI) adapter 26 is used to control high-speed SCSI disk drive 36. Disk drive 36 stores the program instructions and data in a more permanent state, including the program which embodies the present invention as explained further below. Expansion bus bridge 28 is used to couple an industry standard architecture (ISA) expansion bus 38 to PCI local bus 20. As shown, several user input devices are connected to ISA bus 38, including a keyboard 40, a microphone 42, and a graphical pointing device (mouse) 44. Other devices may also be attached to ISA bus 38, such as a CD-ROM drive 46. Audio adapter 30 controls audio output to a speaker 48, and graphics adapter 32 controls visual output to a display monitor 50, to allow the user to control the document creation process as taught herein.

While the illustrative implementation provides the program instructions embodying the present invention on disk drive 36, those skilled in the art will appreciate that the invention can be embodied in a program product utilizing other computer-readable media, including transmission media.

Computer system 10 carries out program instructions for document creation in accordance with one or more of the implementations discussed in detail below. The invention is applicable to a wide variety of documents and document applications, for example, email composers, word processors, and text editors such as HTML language writers, as well as non-textual documents such as graphic or multimedia files. Accordingly, practice of the invention may include the use of conventional document application features in addition to the inventive concept disclosed herein. The details of such applications (i.e., document editors and readers) will become readily apparent to those skilled in the art upon reference to this disclosure.

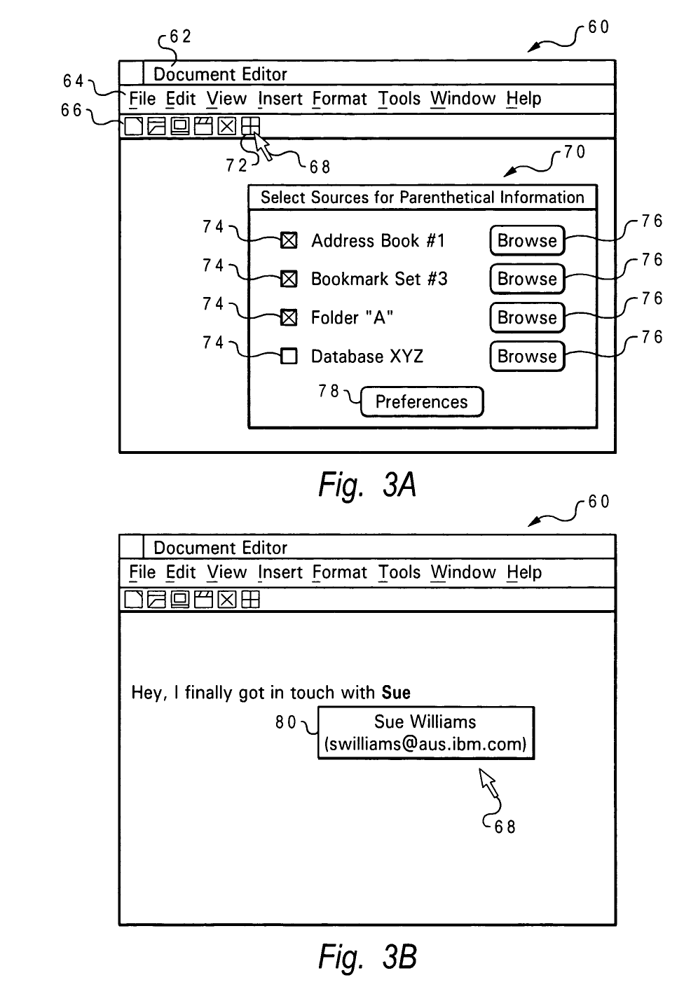

Computer system 10 is programmed to facilitate the creation of an electronic document by including parenthetical information associated with selected portions of the document in a manner which simplifies both the inclusion of the information during creation and the later viewing of the document by a recipient. In the exemplary implementation illustrated in FIGS. 3-5, an email composer running on computer system 10 allows an email correspondent to create an email message with parenthetical information in the form of an embedded link or a file attachment.

FIGS. 3A-3B depict one embodiment of a user interface 60 of the email composer that is displayed on monitor 50 as the document creation process is carried out by computer system 10 under control of the email correspondent. User interface 60 may include general features familiar to computer users such as a title bar 62, a menu bar 64 having various commands which can be executed using keyboard 40 or mouse 44 to display additional pull-down menus, and a button bar 66 having several graphical buttons with icons that allow the user to more simply effectuate a command with a single click of mouse 44 as it controls the graphical pointer 68 on display monitor 50.

Prior to starting any specific email message, the user can establish different sets of parenthetical information which are to be searched as an email is created to dynamically associate set entries with various portions of the message. FIG. 3A illustrates a query or dialog box 70 that is presented to the author in response to a command such as using mouse 40 to control graphical pointer 68 and click on a particular button 72 provided for the purpose of selecting such information sets. In the illustrative implementation, dialog box 70 allows the email author to select from a wide variety of different types of parenthetical information sources, including email address books, HTML bookmark sets, folders containing files stored locally on computer system 10 or remotely on the network, and database files. A series of checkboxes 74 allows the user to toggle between inclusion and exclusion of the information sets for dynamic searching. The name of an information set to be included can be manually typed in one of the fields provided in dialog box 70, or can be selected using a series of “BROWSE” buttons 76 which allow the user to view a directory or listing of available information sets and select one or more of those sets. In the example shown in FIG. 3A, the author has included three sets to be searched for parenthetical information, namely, an address book (“Address Book #1”), a bookmark set (“Bookmark Set #3”), and a folder (“Folder A”), and has excluded any databases.

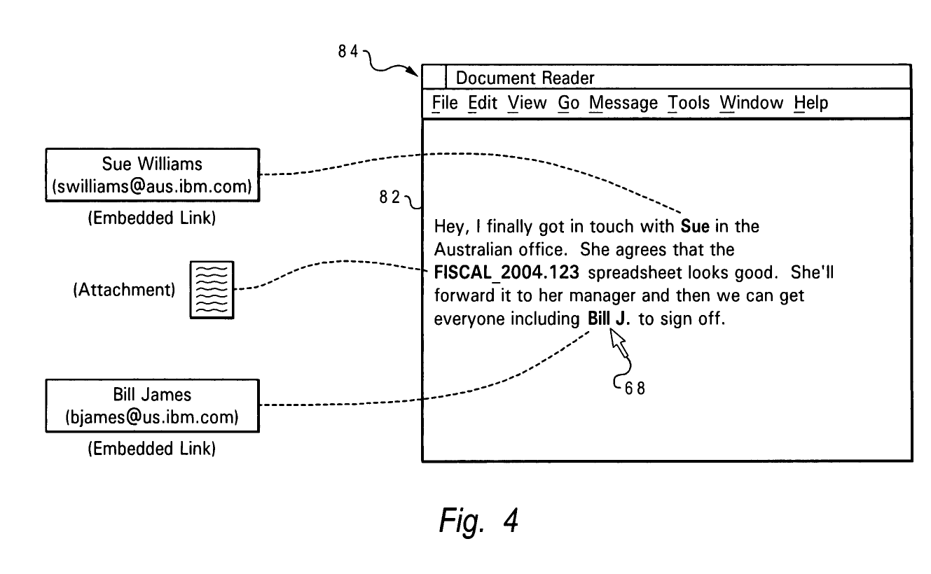

As the author is typing data into the email message, the composer automatically searches the selected information sets for any entries which match a portion of the typed text. This searching for a match is similar to the searching that is performed by a word processor having an integrated dictionary which automatically checks for spelling errors as the author is typing. If a match (including a partial match) is found, the author is offered the choice of associating the set entry with the matching text. The association of the text with the set entry can be accomplished by embedding a link in the message which points to, e.g., a web page, an attached file, or an email address. The associated portion of text may also be rendered more distinctive, such as by underlining or bold font, to indicate that it contains an embedded link. As seen in FIG. 3B, as the user types the name “Sue” in the body of the email message, the email composer searches the selected address book and locates an entry that includes “Sue” in the name. This entry is displayed in a pop-up window 80 and the text “Sue” in the message body is rendered in bold font. The user can select this information for parenthetical association by clicking on the pop-up window, which inserts appropriate code (e.g., HTML) in the message to add the email address information as a link. Additional information besides the email address can be included with the set entry, such as a nickname or telephone number. Once so selected, the word “Sue” in that message becomes an active link which can be queried by the document recipient to access that person's email information (as discussed further below in conjunction with FIG. 4). If the user selects a file for inclusion in this manner, the associated file is automatically added as an attachment to the email message and the embedded link points to this attachment which is sent along with the message to the recipient.

The author may decline to include matching parenthetical information in various ways including explicit commands, but the simplest way is to just ignore pop-window 80 and continue typing the message in which case the email composer will remove pop-window 80 from the display and no association is made.

Returning to FIG. 3A, dialog box 70 also has a “Preferences” button 78 which opens a further dialog box or selection window (not shown) that may be used to set various parameters for carrying out the searching of parenthetical information or the inclusion of such information with the main electronic document. These optional preferences may include, for example:
the ability to select priorities for searching among the designated information sets, e.g., to search an address book first so that any match to a proper name of a person will first pull up an associated email address as opposed to a file or database entry having a similar name (this option may include the selection of secondary, tertiary, etc. priorities, e.g., searching an address book first, then searching a bookmark file second, then searching a database file last);
the ability to select a priority or default information set for certain matches or partial matches, such as associating the specific text ”.123” with searching of the folder “C:Spreadsheets\Lotus\123”; and
the ability to display multiple matches (or partial matches) in one or more pop-up windows and allow the user to select a given one of the set entries for parenthetical inclusion, e.g., when a partial name has been entered (“Bill J.”) that is ambiguous with respect to the entries in an address book (“Bill Johnson” or “Bill James”).

FIG. 4 depicts the delivered message 82 as viewed by the email addressee(s) using a document reader 84 (document reader application 84 and document editor application 60 may be merged into a single software program, e.g., an email user interface). The message is displayed in a document viewer such as an email reader or web browser. As seen in this example, the words “Sue”, “FISCAL_{—}2004.123” and “Bill J.” are all active links have associated parenthetical information, and are appropriately highlighted or otherwise distinctive to indicate that they have embedded links. The parenthetical information associated with the “Sue” and “Bill J.” links comprises the respective email addresses, and the parenthetical information associated with the “FISCAL_{—}2004.123” link is an HTML or similar link pointing to the file which has been included with the message as an attachment. In this manner, the document recipient can view the main body of the message without seeing the associated parenthetical information, which might be superfluous and would otherwise make the message harder to read if it were explicitly included. However, if the document recipient would like to see the additional information, it is easily and instantly accessed by simply activating the appropriate link.

The document viewer can be configured to handle the links according to their nature. For a link comprising an email address, the recipient could view the information by simply holding graphical pointer 68 over the link, which could open a pop-up window with the email address or other information, and when the recipient clicks mouse 44 to select the link, then the document viewer can optionally open an email composer with a new message automatically addressed to the linked email address. For a link comprising a web page address, the document viewer can open a web browser and load the corresponding web page. For a link comprising an attachment, the document viewer can open the appropriate program application associated with the type of attachment, e.g., open a spreadsheet program to load an attachment comprising a spreadsheet file.

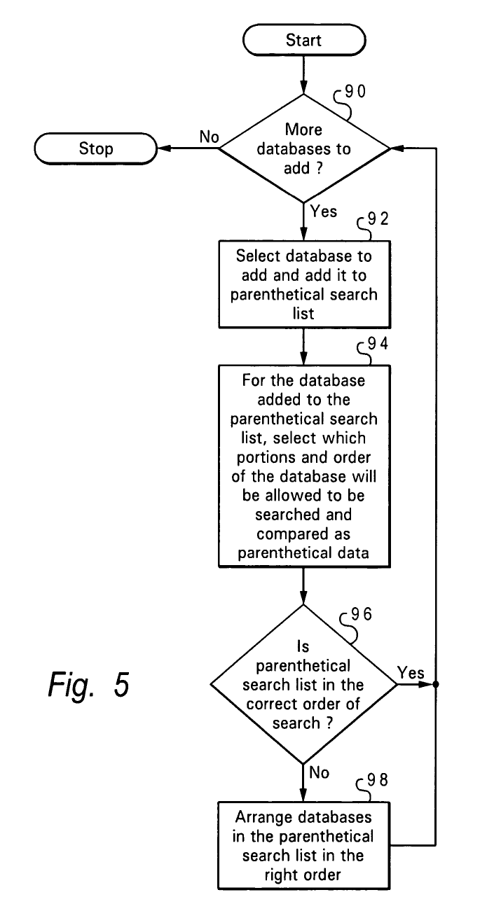

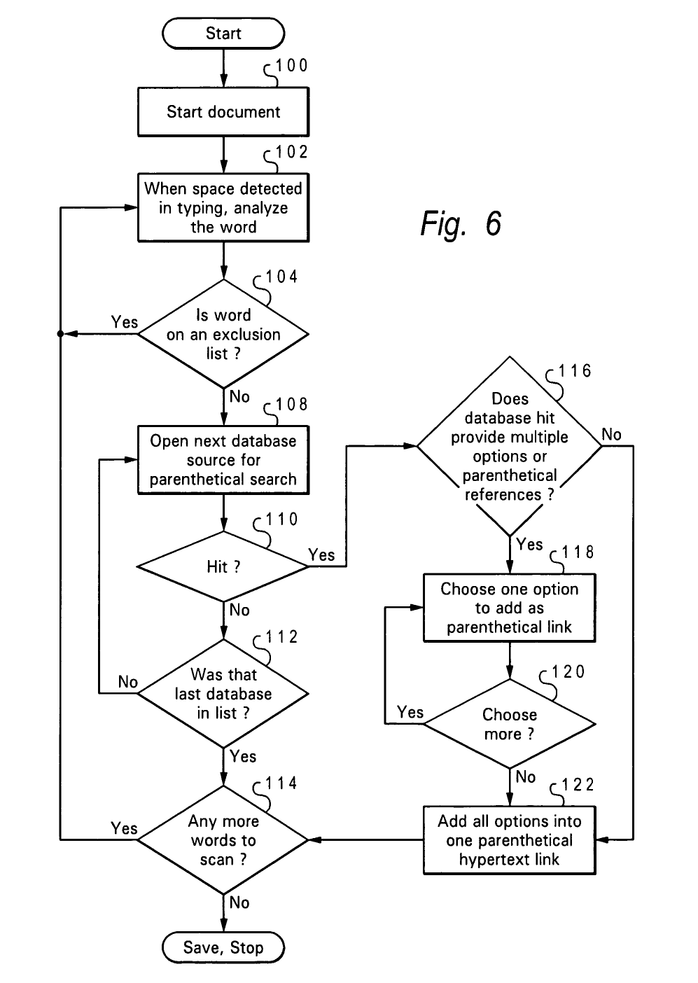

The present invention may be further understood with reference to the flow charts of FIGS. 5 and 6. The setup process is shown in FIG. 5 and begins by adding one or more databases (information sets) for searching against matching text (90). If the user desires to include an additional database, that database is selected via the user interface (dialog box 70) and added to the parenthetical search list (92). For each database so added, the user can select which portions of the database will be allowed to be searched and compared as parenthetical data, and the order/priority of the database (94). The search order of the databases is then checked against the latest selected ordering (96), and the databases are arranged in the proper search order (98). These steps are repeated for each database to be added.

The document creation process is shown in FIG. 6 and begins by using the document editor to open a new document and entering text or other information (100). Different triggers can be established to initiate searching of the databases for a match, and in this implementation a space character is used to demark the ending of a “word” (not limited to alphabetic characters) which is then analyzed (102). The word can be first compared to a list of words to be excluded (e.g., “the,” “this,” etc.) which inhibits further database searching (104). If the word is in the exclusion list, the process returns to step 102 and waits for the next space to be entered. If the word is not in the exclusion list, the first database (according to the preset search priority) is opened for searching (108). The word is then compared to the entries in that database to determine if a “hit” (match) has occurred (110). If there is no match for that word, the process checks whether there are more databases to be searched (112) and, if so, the process repeats iteratively at step 108 with the next database. If the last database to be searched still yields no match, the process checks for further words to search (114), and returns to step 102. If a hit is found in step 110, the searched database is examined to check for multiple options or parenthetical references (116). If there are multiple options or references, the appropriate option/entry is chosen to add as a parenthetical link (118), and this selection can be repeated for each option/entry (120). After the selected options or entries have been chosen (or if there are not multiple options/references), the parenthetical link is associated with the matched word in the document by inserting appropriate code (122). The process returns to step 114 to check for further words to scan, and when no further words are entered (i.e., the document is complete), the process is finished.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, while the invention has been described in the exemplary context of an email communication, it is applicable more generally to any type of electronic document. It is therefore contemplated that such modifications can be made without departing from the spirit or scope of the present invention as defined in the appended claims.

What is claimed is:

1. A method of creating an electronic document comprising:
entering data into an electronic document;
searching one or more information sets to identify a set entry which matches a portion of the entered data; and
inserting a link to information from the set entry into the electronic document, the link being associated with the matched portion of the entered data.

2. The method of claim 1 wherein said searching one or more information sets occurs automatically as the data is entered.

3. The method of claim 1, further comprising designating the one or more information sets for searching from among a plurality of available information sets.

4. The method of claim 3 wherein at least one of the designated information sets is a database file.

5. The method of claim 3 wherein at least one of the designated information sets is a file folder.

6. The method of claim 3 wherein at least one of the designated information sets is a web browser bookmark set.

7. The method of claim 3 wherein at least one of the designated information sets is an email address book.

8. The method of claim 1 wherein the link is inserted in response to selection of the set entry for inclusion in the electronic document.

9. The method of claim 1 wherein the set entry is a separate file, and further comprising attaching the separate file to the electronic document for transmission over a network.

10. A computer system comprising:
means for processing program instructions;
a memory device connected to said processing means; and
program instructions residing in said memory device for entering data into an electronic document, searching one or more information sets to identify a set entry which matches a portion of the entered data, and inserting a link to information from the set entry into the electronic document, the link being associated with the matched portion of the entered data.

11. The computer system of claim 10 wherein said program instructions search the one or more information sets automatically as the data is entered.

12. The computer system of claim 10 wherein said program instructions designate the one or more information sets for searching from among a plurality of available information sets.

13. The computer system of claim 12 wherein at least one of the designated information sets is a database file.

14. The computer system of claim 12 wherein at least one of the designated information sets is a file folder.

15. The computer system of claim 12 wherein at least one of the designated information sets is a web browser bookmark set.

16. The computer system of claim 12 wherein at least one of the designated information sets is an email address book.

17. The computer system of claim 10 wherein said program instructions insert the link in response to selection of the set entry for inclusion in the electronic document.

18. The computer system of claim 10 wherein the set entry is a separate file, and said program instructions attach the separate file to the electronic document for transmission over a network.

19. A computer program product comprising:
a computer-readable medium; and
program instructions residing in said medium for entering data into an electronic document, searching one or more information sets to identify a set entry 5 which matches a portion of the entered data, and inserting a link to information from the set entry into the electronic document, the link being associated with the matched portion of the entered data.

20. The computer program product of claim 19 wherein said program instructions search the one or more information sets automatically as the data is entered.

21. The computer program product of claim 19 wherein said program instructions designate the one or more information sets for searching from among a plurality of available information sets.

22. The computer program product of claim 21 wherein at least one of the designated information sets is a database file.

23. The computer program product of claim 21 wherein at least one of the designated information sets is a file folder.

24. The computer program product of claim 21 wherein at least one of the designated information sets is a web browser bookmark set.

25. The computer program product of claim 21 wherein at least one of the designated information sets is an email address book.

26. The computer program product of claim 19 wherein said program instructions insert the link in response to selection of the set entry for inclusion in the electronic document.

27. The computer program product of claim 19 wherein the set entry is a separate file, and said program instructions attach the separate file to the electronic document for transmission over a network.
